(19) United States
(12) Patent Application Publication
(10) Pub. No.: US 2011/0265262 A1
(43) Pub. Date: Nov. 3, 2011

(54) Extremity support apparatus

(76) Inventors: Michael C. Di Lauro, Carlsbad, CA (US); Brian Brenner, Encinitas, CA (US)

(21) Appl. No.: 12/771,764

(22) Filed: Apr. 30, 2010

(51) Int. Cl. A61G 7/075; A61G 1/04; A61G 5/12

(52) U.S. Cl. 5/621; 297/411.23

(57) ABSTRACT

The invention provides an adjustable apparatus, which is removedly attachable to a medical emergency cot, gurney, wheeled stretcher or the like, and that functions to support and immobilize of an extremity of a human body during patient transport. The apparatus consists of a cot attachment member an extension pole assembly and an extremity support member and wherein certain combinations of relative movements of the extension pole assembly and the extremity support member allow the apparatus to be disposed and secured in positions that support an extremity of a patient lying on the emergency cot and wherein other combinations of relative movements allow the apparatus to be disposed and secured in a storage position. Certain embodiments of the apparatus are attachable to a chair for use in phlebotomy procedures.

### RELATED APPLICATIONS

Co-owned US patent applications U.S. Ser. No. 12/366,610, filed on Feb. 5, 2009 and U.S. Ser. No. 12/699,719, filed on Feb. 3, 2010, are hereby incorporated by reference in their entirety.

### FIELD OF THE INVENTION

The present invention relates generally to extremity supporting devices for use in combination with the patient transporters currently used in hospitals and ambulances, and specifically to an adjustable support device for maintaining an extremity of a patient in a supported position during transport or for a medical procedure.

### BACKGROUND OF THE INVENTION

Various types of ambulatory and medical emergency cots, gurneys, medical beds, medical chairs and wheeled stretchers and the like are utilized in patient transport and it is frequently necessary to administer medication or other fluids intravenously during transport by introducing a conduit into a body extremity of the patient. Most commonly the body extremity is an arm. In order to avoid injury and ensure proper administration, it is important that the patient's body extremity remain relatively immobile and straightened during the procedure. This is particularly important when the patient is transported in a moving vehicle, wherein the close quarters and abrupt movements can combine to produce a potentially hazardous environment. Additionally embodiments of the present invention can be used in combination with blood drawing stations such as phlebotomy chairs.

U.S. Pat. No. 3,528,413 to Aydt describes a splint for an injured arm that attaches to the rail of a bed or a field stretcher wherein the arm splint is attached to the rail via a c-clamp and provides only limited adjustability. Also, since the described arm splint encases the extremity, it does not permit transcutaneous access to the blood vessels of the extremity and therefore precludes procedures such as intravenous therapy.

U.S. Pat. No. 5,443,233 to Kabanek discloses an arm board for a gurney comprising a stiff flat board that not attached to the gurney, but that is rather slipped into crevice below the mattress and thus is held in place by the weight of the patient. Such an arm board configuration is limited in that it fails to provide any adjustability and requires that the arm of the patient be maintained in the same plane as the body.

U.S. Pat. No. 5,839,136 to Vance et al. describes an emergency cot mounted arm board that includes a cot frame attaching member, an arm board, and a pivot assembly coupling the attaching member and the arm board. However the arm board of this invention has limited adjustability since it is attached to the backrest and necessarily remains parallel to the horizontal plane of the cot. Also, the armboard of Vance and is designed to support a patient's hand and lower arm and does not offer independent support to the upper arm. Furthermore, with such a configuration the arm board position changes if the position of the backrest is changed during transport of the patient.

U.S. Pat. No. 6,701,554 to Heimbrock discloses a transportable stretcher used in medical imaging with a pivotally coupled armboard. Since this stretcher is designed specifically for imaging procedures utilizing a C-arm apparatus, the pivotally coupled arm board provides only limited adjustability.

It is therefore an object of the present invention to provide a device, attachable to a medical emergency cot, gurney, wheeled stretcher, medical bed or medical chair to stabilize a body extremity during transport of a patient wherein the device can be easily positioned.

It is another object of the present invention to provide a device, attachable to a medical emergency cot, medical bed, medical chair, gurney or wheeled stretcher, to stabilized a body extremity during transport of a patient wherein the device can be positioned to avoid unwanted pressure or tension on a limb.

It is another object of the present invention to provide a device, attachable to a medical emergency cot, medical bed, medical chair, gurney or wheeled stretcher, to stabilize a body extremity during transport of a patient wherein the device is rigid in design to minimize vibration during patient transport.

It is another object of the present invention to provide a device, attachable to a medical emergency cot, medical bed, medical chair, gurney or wheeled stretcher, to support a body extremity during transport of a patient in a manner that permits transcutaneous access to the blood vessels of the extremity and therefore allows performance of procedures such as intravenous therapy.

It is another object of the present invention to provide a device, attachable to a medical emergency cot, medical bed, medical chair, gurney or wheeled stretcher, to stabilize a body extremity during transport of a patient wherein the device can be conveniently adjusted to fit the full range patient sizes.

It is another object of the present invention to provide a device, attachable to a medical emergency cot, medical bed, medical chair, gurney or wheeled stretcher, to stabilize a body extremity during transport of a patient that provides for convenient and effective immobilization of a patient's extremity if the position of the backrest is changed during transport.

It is another object of the present invention to provide a device, attachable to a medical emergency cot, medical bed, medical chair, gurney or wheeled stretcher, to stabilize a body extremity during transport of a patient wherein the device can be positioned to not exceed the boundary planes defined by the emergency cot when not in use.

It is another object of the present invention to externally rotate beyond the boundary planes defined by the medical emergency cot, medical bed, medical chair, gurney or wheeled stretcher to allow the person administering intravenous procedures to be seated adjacent to the medical bed or medical chair rather than leaning over the patient to perform the intravenous procedure.

It is another object of the present invention to externally rotate beyond the boundary planes defined by the medical emergency cot, medical bed, medical chair, gurney or wheeled stretcher to provide a hand grip contoured to fit the patient's hand which can then be positioned and controlled to give distal access to the patient's extremity during intravenous therapy.

It is another object of the present invention to provide a device, attachable to a medical emergency cot, medical bed, medical chair, gurney or wheeled stretcher that can be used in combination with to a phlebotomy chair so that the present invention stabilizes and holds the extremity in the extended position to safely and effectively draw blood.

It is another object of the present invention to provide an adjustable apparatus that is attachable to an arm of a chair for use in phlebotomy procedures.

These and other objects of the present invention will be apparent from a review of the following specification and accompanying drawings.

### BRIEF DESCRIPTION OF THE DRAWINGS

FIG. 1A is a partially exploded isometric view of an embodiment of an extremity support attached to a component of a medical cot.

FIG. 1B is an orthogonal side view of the extremity support apparatus fixedly attached component of a medical cot that is illustrated in FIG. 1A.

FIG. 2A is an isometric view of an embodiment of an extremity support apparatus fixedly attached to a frame component of a medical cot, wherein the apparatus is in a storage position.

FIG. 2B is an isometric view of the embodiment of extremity support apparatus fixedly attached to a frame component of a medical cot as depicted in FIG. 2A, wherein the apparatus is in a position to support an extremity of a patient lying in the cot.

FIG. 3A depicts an orthogonal front view of an embodiment of an extremity support apparatus.

FIG. 3B depicts an orthogonal side view of an embodiment of an extremity support apparatus.

FIG. 3C depicts an orthogonal rear view of an embodiment of an extremity support apparatus.

FIG. 4 is an isometric view of an embodiment of the extremity support apparatus, as depicted in FIGS. 3A and 3B attached to frame rail of an emergency cot.

FIG. 5A is an isometric view of an embodiment of an extremity support apparatus fixedly attached to a side rail component of a medical cot and disposed a position to support an extremity of a patient lying in the cot.

FIG. 5B is an isometric view of an embodiment of an extremity support apparatus fixedly attached to a side rail component of a medical cot in disposed a storage position.

FIG. 6A is an orthogonal frontal view of an embodiment of an extremity support apparatus configured to be fixedly attachable to a side rail of a medical cot.

FIG. 6B is an orthogonal side view of an embodiment of an extremity support apparatus configured to be fixedly attachable to a side rail of a medical cot.

FIG. 6C is an orthogonal rear view of an embodiment of an extremity support apparatus configured to be fixedly attachable to a side rail of a medical cot.

FIG. 7A is an isometric view of an embodiment of an extremity support apparatus fixedly attached to side rail and frame components of a medical cot wherein the apparatus is in a storage position.

FIG. 7B is an isometric view of an embodiment of an extremity support apparatus fixedly attached to side rail and frame components of a medical cot wherein the apparatus is in an extended position.

FIG. 8A is an isometric view of an embodiment of an extremity support apparatus fixedly attached to side rail and frame components of a medical cot wherein the apparatus is in a storage position and the entire cot is illustrated.

FIG. 8B is an isometric view of an embodiment of an extremity support apparatus fixedly attached to a side rail component of a medical cot wherein the apparatus is in an extended position and the entire cot is illustrated.

FIG. 9 is an isometric view of an embodiment of an extremity support apparatus fixedly attached to an arm of a phlebotomy chair

FIG. 10A is an orthogonal frontal view of an embodiment of an extremity support apparatus configured to be fixedly attachable to a side rail of a medical cot.

FIG. 10B is an orthogonal side view of an embodiment of an extremity support apparatus configured to be fixedly attachable to a side rail of a medical cot.

FIG. 10C is an orthogonal rear view of an embodiment of an extremity support apparatus configured to be fixedly attachable to a side rail of a medical cot.

FIG. 11 is an isometric view of an embodiment of the extremity support apparatus configured to be fixedly attached to a side rail of a medical cot.

FIG. 12 is an isometric view of the embodiment of the extremity support apparatus illustrated in FIG. 11 fixedly attached to a side rail component of a medical cot and disposed a position to support an extremity of a patient lying in the cot.

### SUMMARY OF THE INVENTION

The present invention provides an adjustable device, which is attachable to a medical emergency cot, gurney, wheeled stretcher, medical bed, medical chair or the like, that functions to support and immobilize an extremity of a human body, i.e. limb, during transport or a medical procedure. Embodiments of the device are of simple construction and yet rigid and easily adjustable in several modes from quickly accessible adjustment points. The apparatus can support the limb in a stationary position and can be tilted from one or more horizontal pivot points and rotated around a vertical axis. In general the apparatus is configured to comprises a main support section or member comprising two ends, wherein the first end is pivotally mounted to a cot attachment member, which is attached to a component of a medical emergency bed or cot; an end-support means pivotally mounted on the main member at the second end; and an adjustable limb retaining means rotatably mounted on the end-support. Such an apparatus is of simple construction and yet permits a high degree of adjustability.

A typical embodiment of an extremity support apparatus has a rail attachment member attachable to a rail component of the cot or chair; an extension pole assembly comprising an outer tubular member and an inner tubular member each with a proximal end and a distal end, wherein the outer tubular member is attached to the rail attachment member by a pivotal attachment having a rail attachment locking mechanism to secure the relative positions of the extension pole assembly and the rail component to which it is attached and wherein the inner tubular member is telescopically coupled within the outer tubular member and wherein the outer tubular member comprises an extension pole assembly locking mechanism to secure the relative positions of the inner tubular member and the outer tubular member; and an extremity support member rotatably coupled to the distal end of the inner tubular member wherein the distal end of the inner tubular member comprises an extremity support member locking mechanism to secure the relative positions of the inner tubular member and the extremity support member. Certain combinations of relative movements of the rail attachment member, the outer tubular member, the inner tubular member and the extremity support member allow the apparatus to be disposed in positions that support an extremity of a patient and wherein other combinations of relative movements of the outer tubular member, the inner tubular member and the extremity support member allow the apparatus to be disposed in a storage position. In certain preferred embodiments the rail attachment member comprises a flange having a flat underside that can be attached to the rail by methods such as welding, bolting, soldering, riveting or the like. In certain embodiments the outer tubular member is pivotably attached to the rail attachment member by means of a ball-in-socket joint comprising a ball element at the proximal end of outer tubular member disposed within a socket element attached to, or an integral part of, the flange. In such embodiments one or both of the extension pole assembly locking mechanism and the extremity support member locking mechanism is a friction collar or a collet and the rail attachment locking mechanism is a friction clamp having a lead screw or a quick release clamp having a non-circular cam.

In certain embodiments wherein the rail component is a cot side rail, the rail attachment member is a C-clamp comprising a collar rotatably coupled thereto; wherein the outer tubular member of the extension pole assembly is slidably and rotatably disposed through the collar such that the collar and the extension pole assembly disposed therein can be together rotated within a plane and wherein the collar comprises a locking means to secure the extension pole assembly at a desired position. In certain other embodiments the proximal end of the outer tube further comprises a U-shaped retaining clamp rotatably coupled to the wherein the retaining clamp is configured to accommodate a frame rail of the cot to which the apparatus is attachable such that the frame rail is engaged by the retaining clamp when the apparatus is deployed in an extended position to accommodate an extremity of a patient. In such embodiments the collar comprises a collar locking means such as a friction clamp having a lead screw or a quick release clamp having a non-circular cam is used to secure the extension pole assembly at a desired rotation.

Certain other embodiments an extremity support apparatus of the present invention have a cot side rail attachment member in the form of a C-clamp comprising a collar rotatably coupled thereto; an extension pole slidably and rotatably disposed through the collar such that the collar and the extension pole disposed therein can be together rotated within a plane and wherein the collar comprises a locking means to secure the extension pole at a desired position; and an extremity support rotatably coupled to the distal end of the extension pole wherein the distal end of the extension pole comprises an extremity support locking mechanism to secure the relative positions of the extension pole and the extremity support; wherein certain combinations of relative movements of the collar, the extension pole and the extremity support allow the apparatus to be disposed in positions that support an extremity of a patient and wherein other combinations of relative movements of the collar, the extension pole and the extremity support allow the apparatus to be disposed in a storage position. Certain preferred embodiments of such an apparatus further comprise a U-shaped retaining clamp rotatably coupled to the proximal end of the extension pole wherein the retaining clamp is configured to accommodate a frame rail of the cot to which the apparatus is attached such that the frame rail is engaged by the retaining clamp when the apparatus is deployed in an extended position and the collar has a collar locking mechanism is a friction clamp having a lead screw or a quick release clamp having a non-circular cam.

In certain embodiments the extremity support member has contours disposed around the periphery such that the support member is easily gripped by the hand of a patient.

In certain other embodiments the apparatus is attachable to arm rail of a phlebotomy chair.

Certain other preferred embodiments of the support apparatus attachable to a cot have a cot side rail attachment member comprising a collar rotatably coupled thereto; an extension pole with a proximal end and a distal end, wherein the extension pole is slidably and rotatably disposed through the collar such that the collar and the extension pole can be together rotated within a plane and wherein the collar comprises a locking means to secure the extension pole at a desired position; and an extremity support member rotatably coupled to the distal end of the extension pole; wherein certain combinations of relative movements of the rail attachment member, the extension pole and the extremity support member allow the apparatus to be disposed in positions that support an extremity of a patient and wherein other combinations of relative movements of the rail attachment member, the extension pole and the extremity support member allow the apparatus to be disposed in a storage position. Certain embodiments of such embodiments further comprise a U-shaped retaining clamp rotatably coupled to the proximal end of the extension pole wherein the retaining clamp is configured to accommodate a frame rail of the cot to which the apparatus is attachable such that the frame rail is engaged by the retaining clamp when the apparatus is deployed in an extended position to accommodate an extremity of a patient.

In still other embodiments the cot attachment member has a first movable linkage element; an adjustable pole assembly comprising a first adjustable pole member with a proximal end and a distal end and a second adjustable pole member with a proximal end and a distal end; wherein the proximal end of the first adjustable pole member comprises a second moveable linkable element that is mated to said first movable linkage element to provide a cot attachment moveable linkage; and wherein the distal end of the first adjustable pole member is hingedly or rotatably coupled to the proximal end of the second adjustable pole member; and an extremity support member rotatably coupled to the distal end of the of the second adjustable pole member. In such embodiments the coupling device is a friction clamp having a lead screw, whereby tightening of this clamp controls the position of all three joints at once. In such embodiments certain combinations of relative movements of the first adjustable pole member, the second adjustable pole member and the extremity support allow the apparatus to be disposed and secured in positions that support an extremity of a patient lying on the emergency cot and wherein certain other combinations of relative movements of the first adjustable pole member, the second adjustable pole member and the extremity support allow the apparatus to be disposed and secured in storage positions. In these embodiments the cot attachment moveable linkage is preferably a ball and socket linkage and the extremity support member is rotatably coupled to the distal end of the of the second adjustable pole member by means of a ball and socket linkage.

The present invention also presents a method of affording extremity support for a patient being transported in an emergency cot comprising the steps of: i. providing a suitable apparatus; ii. attaching the apparatus to an emergency cot; iii. adjusting and securing the apparatus in a position appropriate for supporting a patient's extremity; and iii. disposing the patient's extremity within the support member.

In certain embodiments of the apparatus of the present invention the cot attachment member is fixedly attached to a frame rail or side rail component of a medical cot by a means such as welding, riveting and the like to afford a unitary construction.

The present invention provides a method of affording extremity support for a patient being transported in an emergency cot comprising the steps of: i. providing an extremity support apparatus of the present invention attached to an emergency cot; ii. adjusting and securing the apparatus in a position appropriate for supporting a patient's extremity; and iii. disposing the patient's extremity within the support member.

The present invention also provides a method of affording arm support for a patient seated in a chair for a phlebotomy procedure comprises the steps of: i. providing an suitable arm support apparatus of the present invention attached the apparatus to the arm of the a suitable chair; ii. adjusting and securing the apparatus in a position appropriate for supporting a patient's arm; and iii. disposing the patient's extremity within the support member.

### DETAILED DESCRIPTION OF THE INVENTION

For purposes of the present invention the terms medical emergency cot, gurney, transport stretcher, ambulance stretcher, medical bed, medical chair, wheeled stretcher and patient transfer stretcher are synonymous; and the term “fixedly attached” refers to an attachment wherein the attached component remains in a fixed position and is not removed during normal operation of the apparatus.

Generally, the extremity support apparatuses of the present invention have a rail attachment member attachable to a rail component of an emergency cot or phlebotomy chair; an extension pole assembly comprising an outer tube and an inner tube each with a proximal end and a distal end, wherein the outer tube is pivotably attached to the rail attachment member and wherein the inner tube is telescopically coupled within the outer tube; and an extremity support member rotatably coupled to the distal end of the inner tube; wherein certain combinations of relative movements of the rail attachment member, the outer tube, the inner tube and the extremity support member allow the apparatus to be disposed in positions that support an extremity of a patient lying on the emergency cot and wherein other combinations of relative movements of the outer tube, the inner tube and the extremity support member allow the apparatus to be disposed in a storage position. In certain embodiments of an extremity support apparatus at least one of the rail attachment member, extension pole assembly and the extremity support member is provided with a locking means. In certain embodiments movable components such as the extension pole assembly and the support member are provided with a locking means including but not limited to a friction clamp having a lead screw, a quick release clamp having a non-circular cam and a friction collar or collet.

In certain embodiments of the extremity support apparatus the outer tube of the extension pole assembly is pivotably attached to the rail attachment member by means of a ball-in-socket joint comprising a ball element at the proximal end of outer tube that is disposed within a socket element attached to, or an integral part of, a flange type rail attachment member allowing 360 degree processional rotation about an axis perpendicular to the plane of the surface of the cot to which it is attached.

In certain embodiments the apparatus is attachable to a cot side rail and the rail attachment member is rotatably coupled to a collar such that either the outer tube or inner tube of the extension pole assembly can be slidably and rotatably disposed through the collar such that the collar and the extension pole assembly can be rotated together within a plane and wherein the collar has a locking means to secure the extension pole assembly at a desired rotation. In certain other embodiments the above-described apparatus has a U-shaped retaining clamp rotatably coupled to the proximal end of the outer tube. Such a retaining clamp is configured and dimensioned to accommodate a frame rail of the emergency cot to which the apparatus is attachable such that the frame rail is engaged by the retaining clamp when the apparatus is deployed in an extended position to accommodate an extremity of a patient lying in the cot.

In certain embodiments the extremity support apparatus of the present invention is configured and dimensioned to be attachable to arm rail of a phlebotomy chair.

Embodiments of the present invention provide an adjustable apparatus, which is attachable to a medical emergency cot, gurney, wheeled stretcher, medical bed, medical chair or the like to support and immobilize an extremity of a human body, i.e. limb, during transport of a patient. In general such an apparatus has a cot attachment member attachable to a component of a medical cot; an extension pole assembly comprising an outer tube and an inner tube each with a proximal end and a distal end, wherein the outer tube proximal end is pivotably attached to the cot attachment member and wherein the inner tube proximal end is telescopically coupled within the outer tube; and an extremity support member is pivotably coupled to the distal end of the inner tube of the extension pole assembly, wherein certain combinations of relative movements of the extension pole assembly and the extremity support member allow the apparatus to be disposed and secured in positions that support an extremity of a patient lying on the emergency cot and wherein other combinations of relative movements of the extension pole assembly and the extremity support member allow the apparatus to be disposed and secured in a storage position.

Suitable cot attachment member configurations include, but are not limited to, flanges, C-clamps, G-clamps and the like; and wherein the attachment members can be secured to components of a medical cot by various methods in including, but not limited to bolting, clamping, welding, riveting and the like as well as combinations thereof.

In certain embodiments the cot attachment member is attachable to a frame rail of the cot while in certain other embodiments the cot attachment member is attachable to a side rail of the cot. In still other embodiments the cot attachment member is an integral element of a cot component such as a frame rail or side rail.

In certain preferred embodiments telescopic coupling of the outer tube and an inner tube of the extension pole assembly renders these tubes slidably and rotatably movable with respect to one another, while the extremity support member is rotatably coupled to the distal end of the inner tube of the extension assembly. Such a configuration of components permits a combination of movements or adjustments of the components to deploy and secure the apparatus in the optimum position to function as an effective support for an extremity of a patient, while other combinations of movements or adjustments permits the apparatus to be secured in a protected storage position.

In certain embodiments the extremity support member is contoured to conform to the shape of a patient's extremity and other embodiments the extremity support member further comprises a replaceable pad. In certain other embodiments the extremity support member has contours disposed around the periphery such that the support member is easily gripable by the hand of a patient is particularly useful.

In certain preferred embodiments the apparatus comprises a cot attachment member that is fixedly attachable to a side rail of a medical cot; a collar rotatably coupled to the cot attachment member through which the outer tube of an extension pole assembly is slidably and rotatably disposed. In such embodiments, in addition to the relative movements of the inner and outer tubes of the extension pole assembly by virtue of the telescopic coupling thereof, both the collar and the extension pole assembly disposed therein can be rotated 360 degrees within a plane and secured at desired rotation via a suitable locking means. In certain an embodiments the cot attachment member has the form of a lockable C-clamp that maintains intimate contact with the surface of the side rail to which is fixedly attached.

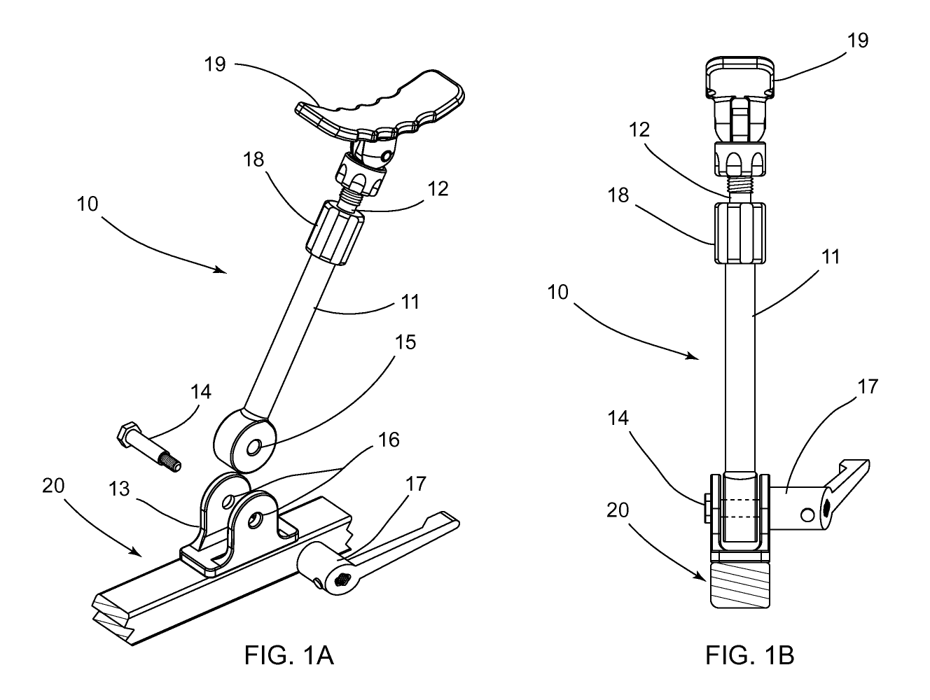

In FIG. 1A is illustrated a partially exploded isometric view of an embodiment of an extremity support apparatus 10 fixedly attached to a medical cot component 20 and in FIG. 1B is illustrated an orthogonal side view of the extremity support apparatus 10 of FIG. 1A fixedly attached to medical cot component 20. The medical cot component 20 represents either a frame rail or a side rail. The support apparatus 10 has an extension pole assembly comprising an inner tube 12 telescopically coupled within an outer tube 11 wherein the proximal end of outer tube 11 is pivotably attached to a cot attachment member 13 by means of a pin 14 extending through a suitably sized hole 15 in the proximal end of outer tube 11 and suitably sized and disposed holes 16 in the cot attachment member 13. Also provided in this embodiment is an extension pole locking means in the form of a lever actuated friction clutch mechanism 17 used to secure the extension pole assembly in a desired position. In such an embodiment the extension pole assembly can be adjusted to positions varying about 180 degrees within a plane defined by the frame component 20. The apparatus 10 is also provide with a locking collet 18 that functions to retain the position of the inner tube 12 relative to the outer tube 11 with respect to rotation and extension. In such an embodiment the inner tube 12 can rotate 360 degrees about its longitudinal axis. A particularly suitable mechanism for the locking collet 18 is the friction-type locking device commonly used in camera tripods. Also in this embodiment an extremity support member 19 is pivotably attached to the distal end of inner tube 12. In variations of such embodiments as well as variations thereof the extremity support member 19 can be pivoted between 180 and 360 degrees about its point of pivotal attachment to the distal end of inner tube 12. Overall, certain combinations of relative movements of the extension pole assembly outer tube 11 and inner tube 12 and extremity support 19 allow the extremity support apparatus 10 to be disposed and secured in positions to support an extremity of a patient lying on an emergency cot and wherein certain other combinations of relative movements of the extension pole assembly and the extremity support member allow the apparatus 10 to be disposed and secured in a storage position in close proximity to the medical cot component 20.

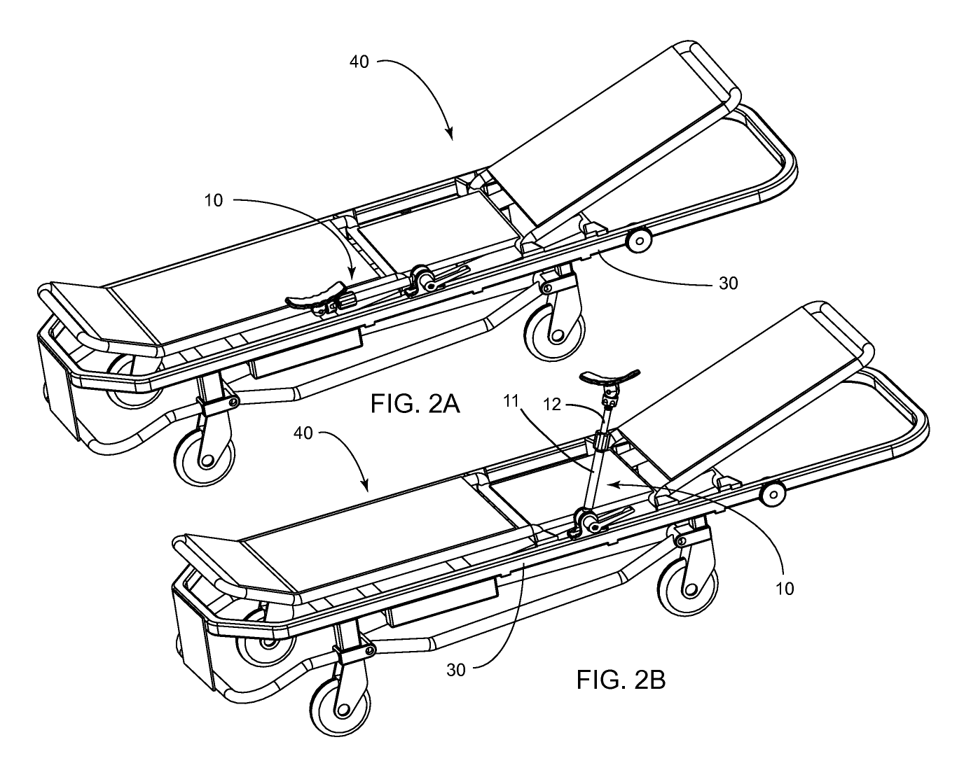

In FIG. 2A is depicted the extremity support apparatus 10 of FIG. 1 fixedly attached to a frame rail 30 of a medical cot 40, wherein the apparatus 10 is disposed in a storage position in close proximity to the frame rail 30. In FIG. 2B is depicted the extremity support apparatus 10 of FIG. 1 fixedly attached to frame rail 30 of medical cot 40, wherein the apparatus 10 is disposed in a position to support an extremity of a patient lying on the cot 40.

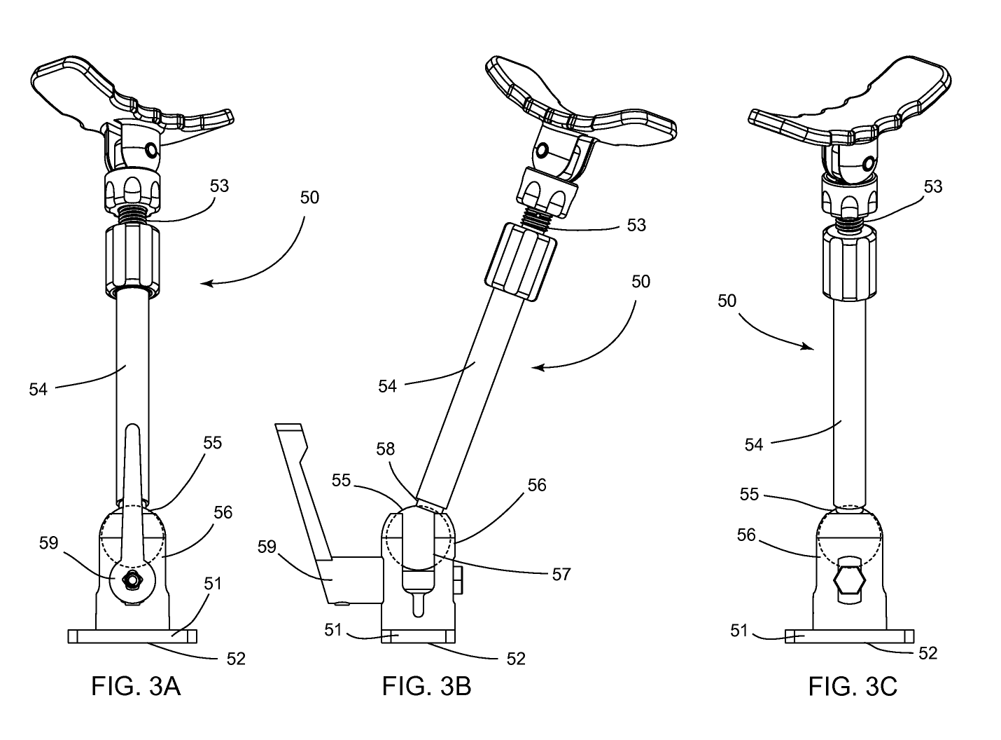

FIGS. 3A, 3B and 3C depict an orthogonal front view, side view and rear view respectively of an embodiment of an extremity support apparatus 50 having a cot attachment member in the form of a flange 51 having a flat surface 52; an extension pole assembly comprising an inner tube 53 telescopically coupled within an outer tube 54 such that the inner tube 53 can be rotated 360 degrees about its longitudinal axis. The proximal end of outer tube 54 is a ball element 55 that is disposed within a socket or cup element 56 that is fixedly attached to, or an integral part of, the flange 51 allowing 360 degree processional rotation about an axis perpendicular to a plane defined by the flat surface 52. Also the socket element 56 is configured to define a slot 57 sized to accommodate the proximal end 58 of the outer tube 54. Such a ball and socket arrangement permits the extension pole assembly to be disposed in positions varying approximately 180 degrees relative to a plane defined by the flat surface 52 of the flange 51, wherein the extension pole assembly can be secured in a desired position by a locking means in the form of a lever actuated friction clutch mechanism 59.

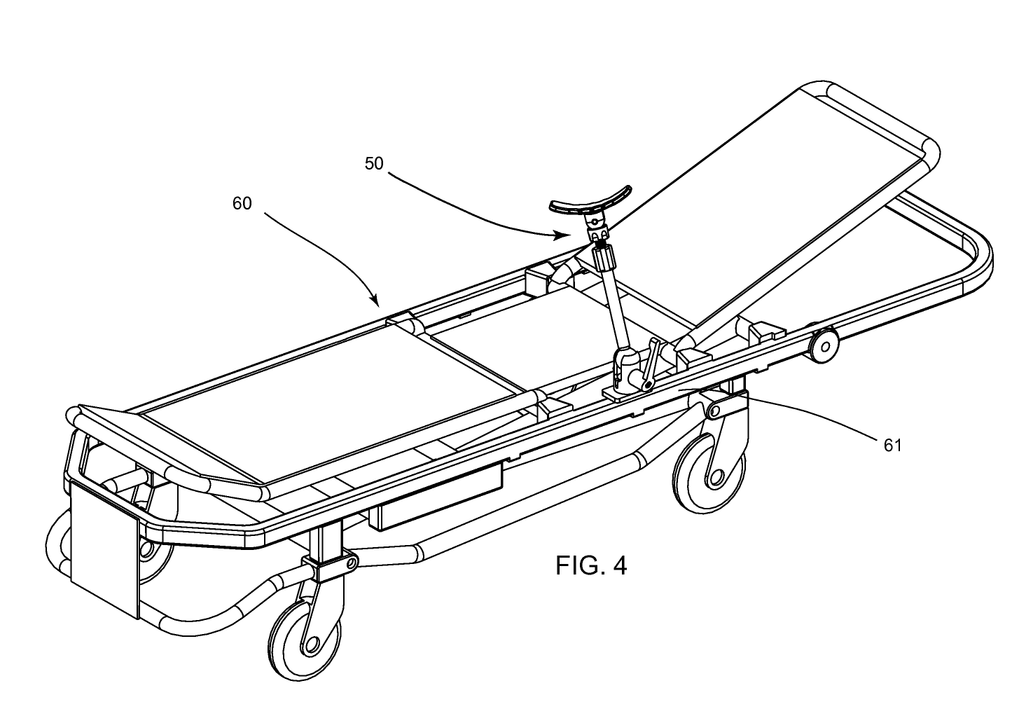

In FIG. 4 is depicted the apparatus 50 of FIGS. 3A, 3B and 3C fixedly attached to a frame rail 61 of a medical cot 60, wherein the apparatus 50 is disposed in a position to support an extremity of a patient lying on the cot 60.

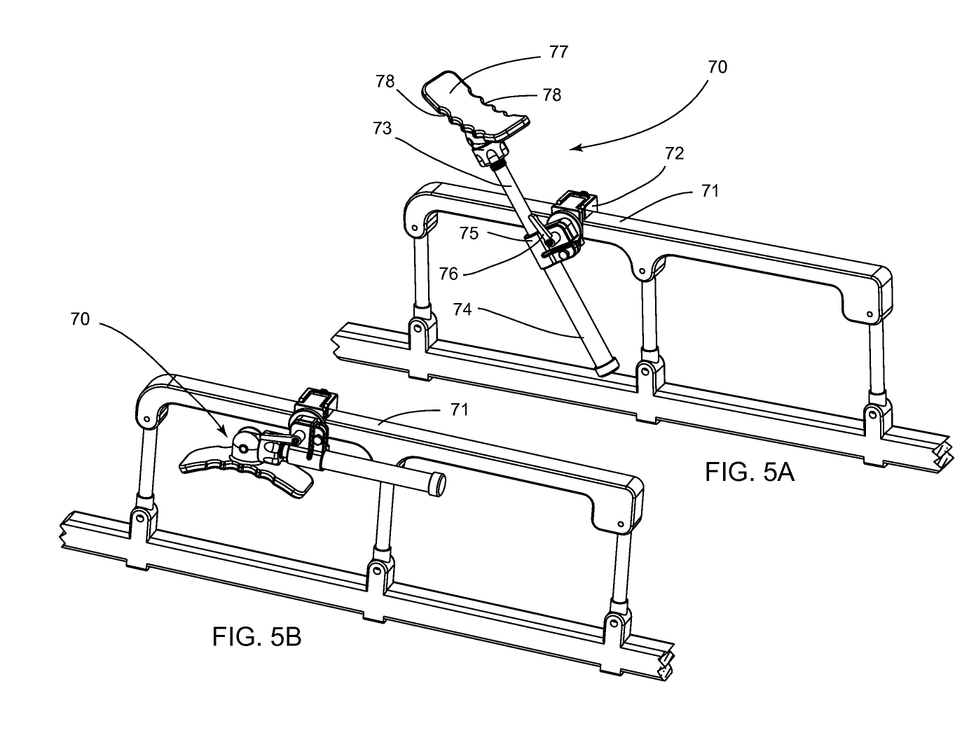

In FIG. 5A is depicted an embodiment of an extremity support apparatus 70 attached to a medical cot side rail 71 wherein the apparatus 70 is disposed a position to support an extremity of a patient lying in the cot. In FIG. 5B is depicted the extremity support apparatus 70 of FIG. 5A attached to medical cot side rail 71 wherein the apparatus 70 is disposed a storage position. In such an embodiment extremity support apparatus 70 cot attachment member 72 has the form of a lockable C-clamp that maintains intimate contact with three surface of the side rail 71 to which it is fixedly or removeably attached. In this embodiment the extension pole assembly consists of an inner tube 73 telescopically disposed within an outer tube 74 that is disposed through a collar 75 such that it can be rotated 360 degrees about its longitudinal axis. The collar 75 is rotatably attached to attachment member 72 such that both the collar 75 and the extension pole assembly disposed therein can be rotated 360 degrees and wherein the collar 75 can be secured in a desired position via a locking means, which in the depicted embodiment has the form of a lever actuated friction clutch mechanism 76. Also in this embodiment the extremity support element 77 is ergonomically designed to provide hand contours 78 that function to render such embodiments particularly useful in securely supporting the hand of a patient. In must be noted that while the extension pole assembly of the extremity support apparatus embodiment 70 depicted in FIGS. 5A and 5B consists of an inner tube member telescopically disposed within an outer tube member, the invention is in no way limited to such embodiments. In certain other embodiments, although not herein illustrated, the extension pole assembly comprises a single tube slidably and rotatably disposed with in a collar such as the collar 75 herein illustrated may be preferred.

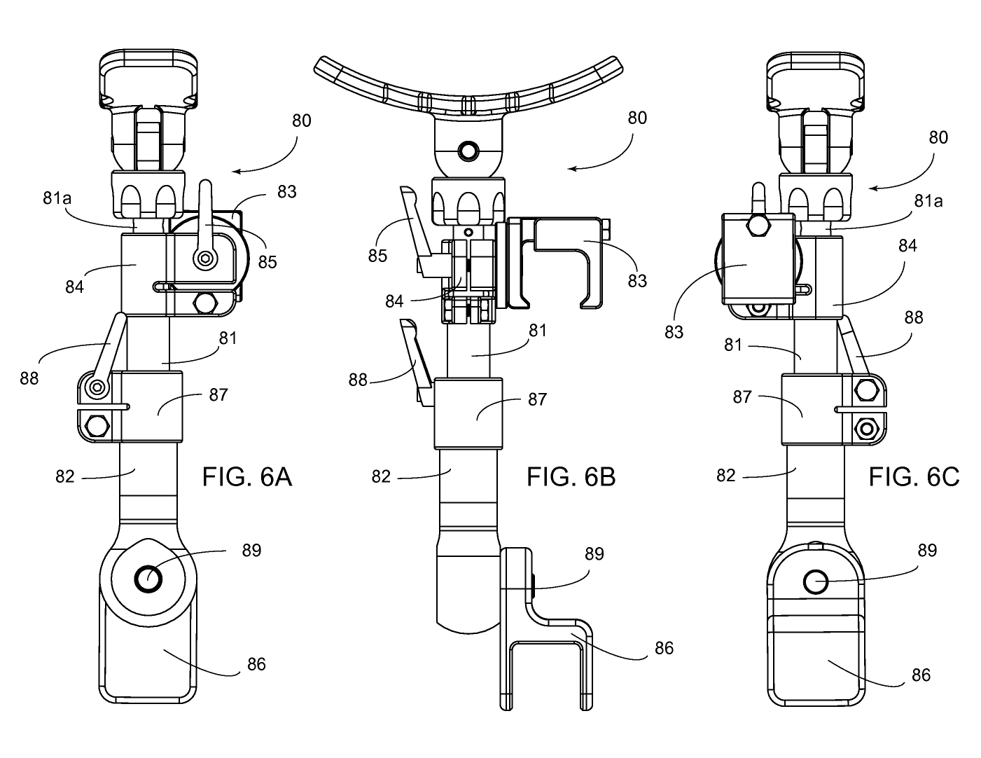

In FIGS. 6A, 6B and 6C are depicted orthogonal frontal, side and rear views respectively of an embodiment of an extremity support apparatus 80. In this 540 embodiment an extension pole assembly comprises an inner tube 81 telescopically disposed within outer tube 82 such that the inner tube 81 can be rotated 360 degrees and elongated relative to outer tube 82 along its longitudinal axis and an extremity support element 81a in the form of a tube telescopically disposed within the inner tube 81 such that the extremity support element 81a can be rotated 360 degrees and can elongated relative to the inner tube 81 along its longitudinal axis. The apparatus 80 is also provide with a locking collar 87 that functions to retain position of the inner tube 81 relative to the outer tube 82 with respect to rotation and extension. A cot attachment member 83 has the form of a lockable C-clamp dimensioned to accommodate a side rail of a medical cot. A collar 84 is rotatably attached to the cot attachment member 83 and the inner tube 81 is disposed through the collar 84 such that the inner tube 81 can be rotated 360 degrees about its longitudinal axis while both the collar 84 and the extension pole assembly disposed therein can be rotated 360 degrees. The collar 84 can be secured in a desired position via a locking means 85, which in the depicted embodiment has the form of a lever actuated friction clutch mechanism. The proximal end of outer tube 82 is rotatably coupled to a U-shaped retaining clamp 86 that is dimensioned to securely accommodate a frame rail of an emergency cot to which the apparatus 80 is attachable.

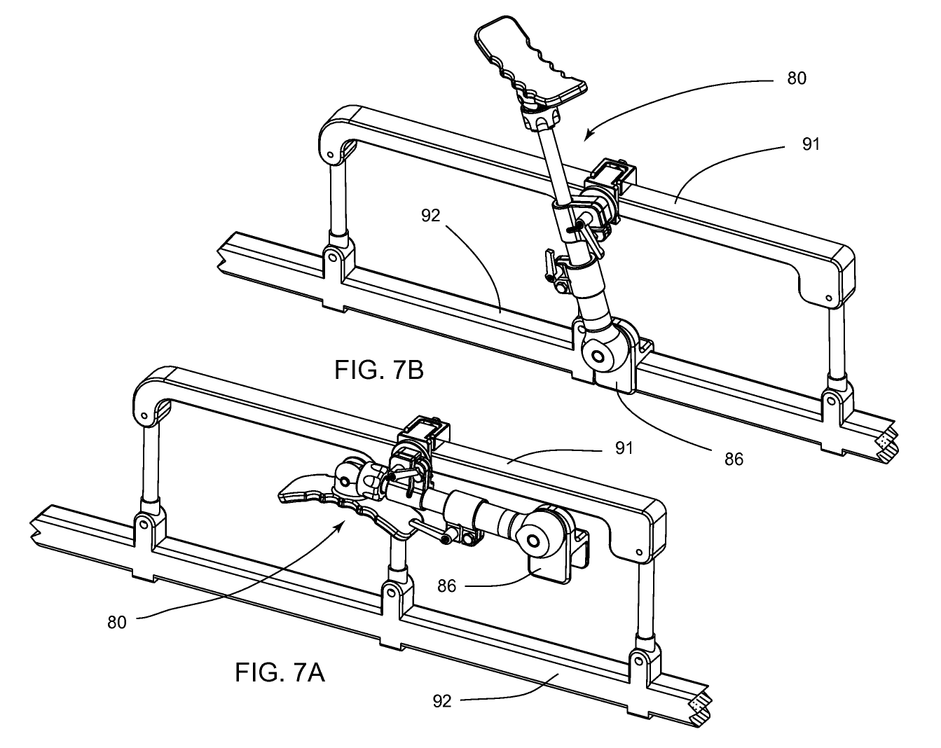

In FIG. 7A is illustrated an isometric view of the extremity support apparatus 80, which is depicted in FIGS. 6A, 6B and 6C, wherein the cot attachment member 83 is fixedly attached to a side rail 91 of a medical cot and wherein the apparatus 80 is in a compacted storage position such that the U-shaped retaining clamp 86 is disengaged form the frame rail 92. In FIG. 7B is illustrated an isometric view of the extremity support apparatus 80, which is depicted in FIGS. 6A, 6B and 6C, wherein the cot attachment member 83 is fixedly attached to a side rail 91 of a medical cot and wherein the apparatus 80 is in an extended position to accommodate an extremity of a patient lying in the cot. When the apparatus 80 is deployed in such extended position to accept an arm of a patient the cot frame rail 92 is engaged within the retaining clamp 86 adding stability during use.

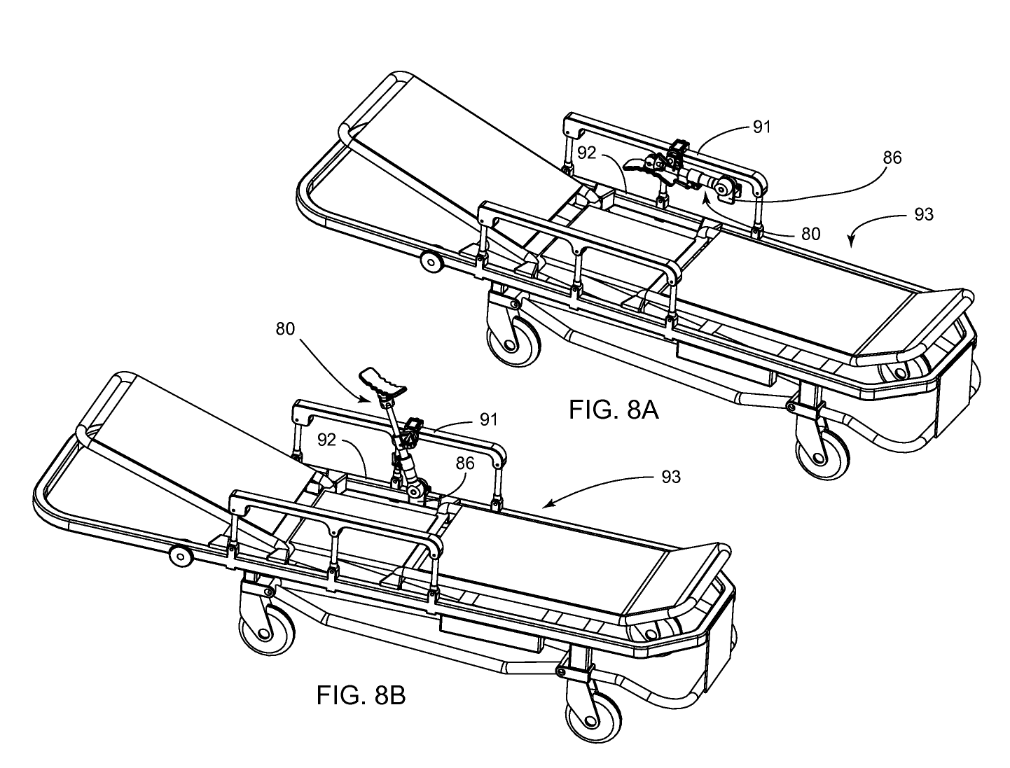

In FIG. 8A is illustrated an isometric view of the extremity support apparatus 80, which is depicted in FIGS. 6A, 6B and 6C, fixedly attached to the side rail 91 of a medical cot 93 wherein the apparatus 80 is in a compacted storage position wherein the apparatus is in a storage position such that the U-shaped retaining clamp 86 is disengaged form the frame rail 92. In FIG. 8B is illustrated an isometric view of the extremity support apparatus 80, which is depicted in FIGS. 6A, 6B and 6C, fixedly attached to a side rail 91 medical cot 92 wherein the apparatus 80 is in an extended position to accommodate an extremity of a patient lying in the cot 92. When the apparatus 80 is deployed in such extended position the cot frame rail 92 is engaged within the retaining clamp 86 adding stability during use.

Certain embodiments of the invention provide an adjustable apparatus to support and immobilize an arm of a patient during phlebotomy procedures. In general such an apparatus comprises a chair attachment member attachable to an arm of a phlebotomy chair; an extension pole assembly comprising an outer tube and an inner tube each with a proximal end and a distal end, wherein the outer tube proximal end is pivotably attached to the chair attachment member and wherein the inner tube proximal end is telescopically coupled within the outer tube; and an extremity support member is pivotably coupled to the distal end of the inner tube of the extension pole assembly. In such an embodiment certain combinations of relative movements of the extension pole assembly and the extremity support member allow the apparatus to be disposed and secured in positions that support an arm of a patient sitting in the chair for a phlebotomy procedures wherein other combinations of relative movements of the extension pole assembly and the extremity support member allow the apparatus to be disposed and secured in a storage position.

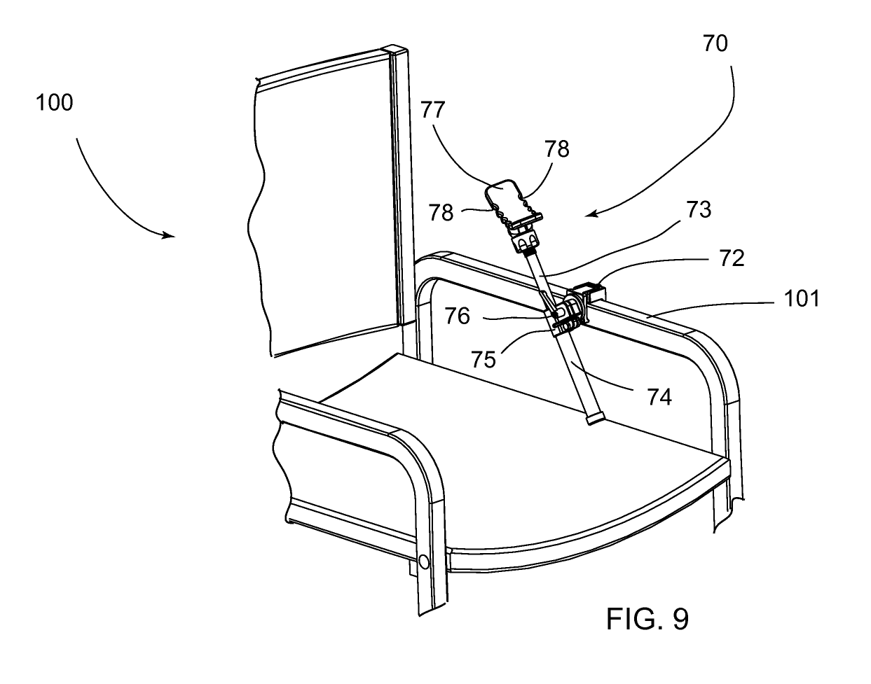

In FIG. 9 is depicted the extremity support apparatus 70 (previously illustrated in FIGS. 5A and 5B, attached to arm rail 101 of a phlebotomy chair 100 by means of an attachment member 72 wherein the apparatus 70 is disposed a position to support an arm of a patient seated in the chair 100 for a phlebotomy procedure. In such an embodiment the attachment member 72 has the form of a lockable C-clamp that maintains intimate contact with three surface of the arm rail 101 to which is fixedly attached. In this embodiment the extension pole assembly consists of an inner tube 73 telescopically disposed within an outer tube 74 that is disposed through a collar 75 such that it can be rotated 360 degrees about its longitudinal axis. The collar 75 is rotatably attached to attachment member 72 such that both the collar 75 and the extension pole assembly disposed therein can be rotated 360 degrees and wherein the collar 75 can be secured in a desired position via a locking means, which in the depicted embodiment has the form of a lever actuated friction clutch mechanism 76. Also in this embodiment the extremity support element 77 is ergonomically designed to provide hand contours 78 that function to render such embodiments particularly useful in securely supporting the hand of a patient.

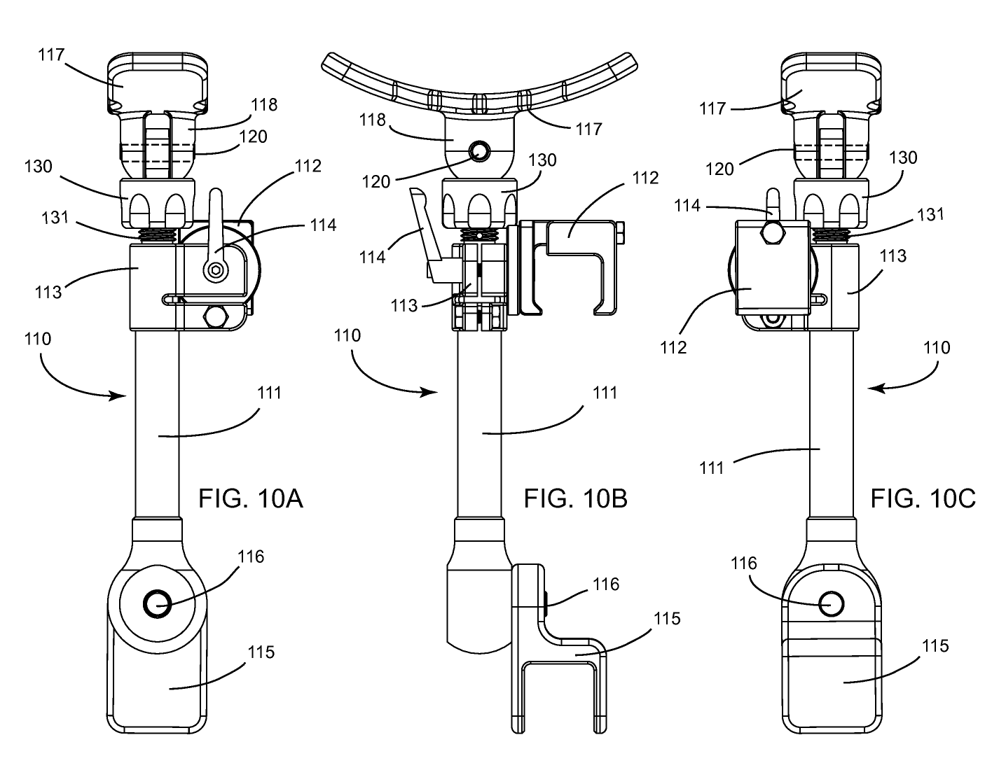

In FIGS. 10A, 10B and 10C are depicted orthogonal frontal, side and rear views respectively of an embodiment of an extremity support apparatus 110 having an extension pole assembly comprising an outer tube member 111 and an inner tube member 131, wherein the proximal end of the inner tube member 131 is telescopically coupled within the outer tube member 111. The proximal end of the outer tube member 111 is rotatably coupled to a U-shaped retaining clamp 115 by means of a pin 116, wherein the U-shaped retaining clamp 115 is dimensioned to securely accommodate a frame rail of an emergency cot to which the apparatus 110 is attachable. The distal end of the outer tube member 111 is disposed and secured within a collar 113 that is rotatably coupled to a cot attachment member 112. The distal end of the inner tube 131 is pivotally coupled to extremity support member 117 by means of a coupling pin 120 extending through a first suitably sized and configured opening or hole in the slotted flange element 118 and through a second suitably sized and configured opening or hole in the distal end of the inner tube 131, which is configured to be disposed within the slotted flange element 118. Additionally, the position of the extremity support member 117 relative to the inner tube 131 can be secured by means of a threaded locking ring 130 disposed around a threaded portion of the distal end of the inner tube 131. In such an embodiment the arrangement of the inner tube 131, the collar 113 and the cot attachment member 112 allows the inner tube 131 to be rotated 360 degrees and extended about its longitudinal axis. Also in this embodiment the cot attachment member 112 has the form of a lockable C-clamp dimensioned to accommodate a side rail of a medical cot and the collar 113 can be secured in a desired position via a locking means, which in the embodiment depicted has the form of a lever actuated friction clutch mechanism 114.

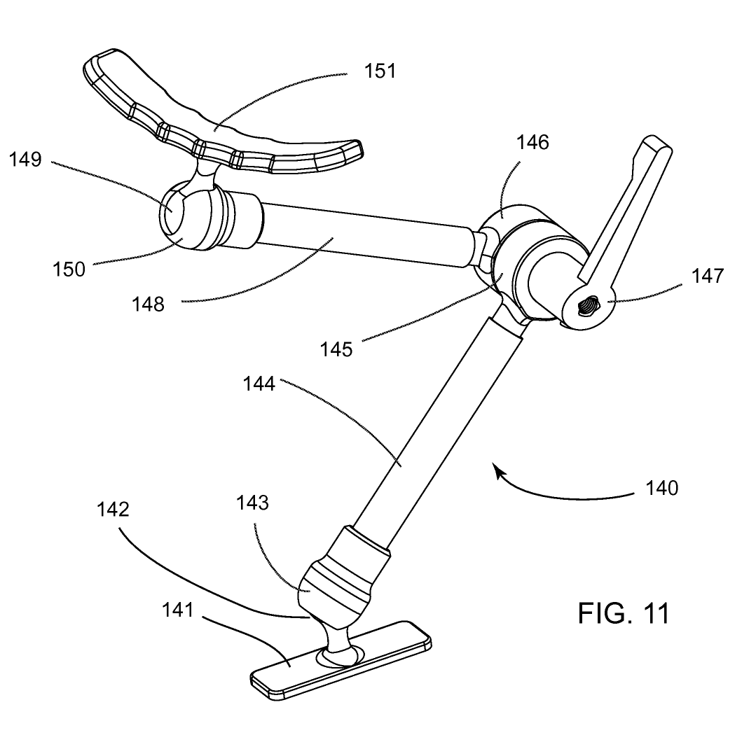

In FIG. 11 is shown an isometric view of an embodiment of an extremity support apparatus 140 having a cot attachment member 141 in the form of a flange that can be secured to a cot rail by techniques such as welding, soldering, bolting, riveting and the like; an extension pole assembly comprising a first extension pole member 144 and a second extension pole member 148; and an extremity support member 151. In this embodiment the first extension pole member 144 is moveably coupled to the cot attachment member 141 by means of a ball-in-socket coupling, wherein a first ball element 142 of cot attachment member 141 is mated to first cup element 143 at the proximal end of the first extension pole member 144. The relative positions of the first extension pole member 144 and the cot attachment member 141 can be fixed by means of friction-type locking mechanism incorporated into the ball-in-socket coupling. The distal end of the first extension pole member 144 is pivotably or rotatably coupled to the proximal end of the second extension pole member 148. In the embodiment illustrated by FIG. 11 the pivotal or rotatable coupling is realized by the use of a pair of bearings 145 and 146, disposed at the distal end of the first extension pole member 144 and the proximal end of the second extension pole member 148 respectively. The relative positions of the first extension pole member and the second extension pole member can be fixed by means of a lever actuated friction clutch-type locking mechanism 147. The extremity support member 151 is moveably coupled to the to the distal end of the second extension pole member 148 by means of a ball-in-socket coupling, wherein a second ball element 149 of extremity support member 151 is mated to a second cup element 150 located at the distal end of second extension pole member 148. The relative positions of the second extension pole member 148 and the cot attachment member 151 can be fixed by means of friction-type locking mechanism incorporated into the ball-in-socket coupling. In such an embodiment certain combinations of relative movements of the first extension pole member, the second extension pole member and the extremity support allow the apparatus to be disposed and secured in positions that support an extremity of a patient lying on the emergency cot and wherein certain other combinations of relative movements of the first extension pole member, the second extension pole member and the extremity support allow the apparatus to be disposed and secured in storage positions.

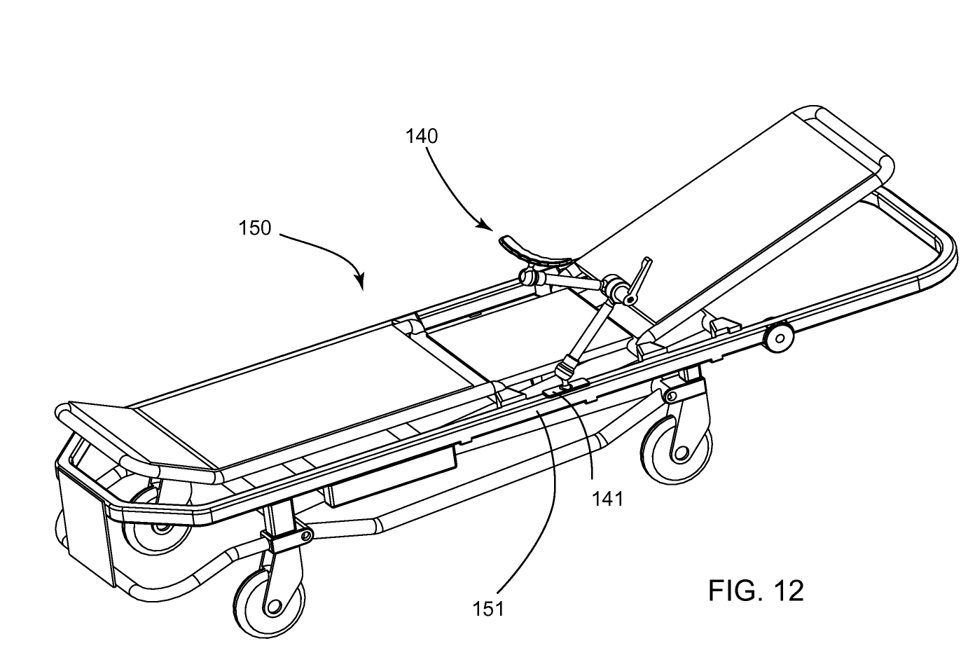

In FIG. 12 is depicted an isometric view of the extremity support apparatus 140 illustrated in FIG. 11 fixedly attached to a rail 151 of an emergency cot 150, wherein the apparatus 140 is disposed a position to support an extremity of a patient lying in the cot 150.

Preferred materials of construction for components of embodiments extremity support apparatus of the present invention include, but are not limited to, metal such as aluminum or steel as well as combinations thereof. The most preferable material is stainless steel. Use of such metals decreases the likelihood of rusting and/or pitting of components and increases the ease of cleaning. Also use of such materials imparts a substantial durability and sturdiness to the apparatus.

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

We claim:

1. An extremity support apparatus comprising:
A rail attachment member attachable to a rail component of the cot or chair;
an extension pole assembly comprising an outer tubular member and an inner tubular member each with a proximal end and a distal end, wherein the outer tubular member is attached to the rail attachment member by a pivotal attachment having a rail attachment locking mechanism to secure the relative positions of the extension pole assembly and the rail component to which it is attached and wherein the inner tubular member is telescopically coupled within the outer tubular member and wherein the outer tubular member comprises an extension pole assembly locking mechanism to secure the relative positions of the inner tubular member and the outer tubular member; and
an extremity support member rotatably coupled to the distal end of the inner tubular member wherein the distal end of the inner tubular member comprises an extremity support member locking mechanism to secure the relative positions of the inner tubular member and the extremity support member; wherein certain combinations of relative movements of the rail attachment member, the outer tubular member, the inner tubular member and the extremity support member allow the apparatus to be disposed in positions that support an extremity of a patient and wherein other combinations of relative movements of the outer tubular member, the inner tubular member and the extremity support member allow the apparatus to be disposed in a storage position.

2. The apparatus of claim 1 wherein the rail attachment member comprises a flange.

3. The apparatus of claim 2 wherein the outer tubular member is pivotably attached to the rail attachment member by means of a ball-in-socket joint comprising a ball element at the proximal end of outer tubular member disposed within a socket element attached to, or an integral part of, the flange.

4. The apparatus of claim 1 wherein at least one of the extension pole assembly locking mechanism and the extremity support member locking mechanism is a friction collar or a collet.

5. The apparatus of claim 1 wherein the rail attachment locking mechanism is a friction clamp having a lead screw or a quick release clamp having a non-circular cam.

6. An apparatus of claim 1 wherein in the rail component is a cot side rail and the rail attachment member is a C-clamp comprising a collar rotatably coupled thereto; wherein the outer tubular member of the extension pole assembly is slidably and rotatably disposed through the collar such that the collar and the extension pole assembly disposed therein can be together rotated within a plane and wherein the collar comprises a locking means to secure the extension pole assembly at a desired position.

7. The apparatus of claim 6 further comprising a U-shaped retaining clamp rotatably coupled to the proximal end of the outer tube wherein the retaining clamp is configured to accommodate a frame rail of the cot to which the apparatus is attachable such that the frame rail is engaged by the retaining clamp when the apparatus is deployed in an extended position to accommodate an extremity of a patient.

8. An apparatus of claim 6 wherein the collar comprises a collar locking means to secure the extension pole assembly at a desired rotation.

9. The apparatus of claim 8 wherein the collar locking mechanism is a friction clamp having a lead screw or a quick release clamp having a non-circular cam.

10. An extremity support apparatus comprising:
a cot side rail attachment member in the form of a C-clamp comprising a collar rotatably coupled thereto;
an extension pole slidably and rotatably disposed through the collar such that the collar and the extension pole disposed therein can be together rotated within a plane and wherein the collar comprises a locking means to secure the extension pole at a desired position; and
an extremity support rotatably coupled to the distal end of the extension pole wherein the distal end of the extension pole comprises an extremity support locking mechanism to secure the relative positions of the extension pole and the extremity support; wherein certain combinations of relative movements of the collar, the extension pole and the extremity support allow the apparatus to be disposed in positions that support an extremity of a patient and wherein other combinations of relative movements of the collar, the extension pole and the extremity support allow the apparatus to be disposed in a storage position.

11. The apparatus of claim 10 further comprising a U-shaped retaining clamp rotatably coupled to the proximal end of the extension pole wherein the retaining clamp is configured to accommodate a frame rail of the cot to which the apparatus is attached such that the frame rail is engaged by the retaining clamp when the apparatus is deployed in an extended position to accommodate an extremity of a patient.

12. An apparatus of claim 10 wherein the collar comprises a collar locking means to secure the extension pole at a desired rotation.

13. The apparatus of claim 12 wherein the collar locking mechanism is a friction clamp having a lead screw or a quick release clamp having a non-circular cam.

14. The apparatus of claim 1 wherein the extremity support member has contours disposed around the periphery such that the support member is easily gripable by the hand of a patient.

15. The apparatus of claim 1 wherein the rail attachment member is attachable to arm rail of a phlebotomy chair.

16. An extremity support apparatus attachable to a cot comprising:
a cot side rail attachment member comprising a collar rotatably coupled thereto;
an extension pole with a proximal end and a distal end, wherein the extension pole is slidably and rotatably disposed through the collar such that the collar and the extension pole can be together rotated within a plane and wherein the collar comprises a locking means to secure the extension pole at a desired position; and
an extremity support member rotatably coupled to the distal end of the extension pole; wherein certain combinations of relative movements of the rail attachment member, the extension pole and the extremity support member allow the apparatus to be disposed in positions that support an extremity of a patient and wherein other combinations of relative movements of the rail attachment member, the extension pole and the extremity support member allow the apparatus to be disposed in a storage position.

17. The apparatus of claim 15 further comprising a U-shaped retaining clamp rotatably coupled to the proximal end of the extension pole wherein the retaining clamp is configured to accommodate a frame rail of the cot to which the apparatus is attachable such that the frame rail is engaged by the retaining clamp when the apparatus is deployed in an extended position to accommodate an extremity of a patient.

18. An apparatus attachable to an emergency cot comprising:
a cot attachment member comprising a first movable linkage element;
an extension pole assembly comprising a first extension pole member with a proximal end and a distal end and a second extension pole member with a proximal end and a distal end; wherein the proximal end of the first extension pole member comprises a second moveable linkable element that is mateable with said first movable linkage element to provide a cot attachment moveable linkage; and wherein the distal end of the first extension pole member is hingedly or rotatably coupled to the proximal end of the second extension pole member; and
an extremity support member rotatably coupled to the distal end of the of the second extension pole member; wherein
certain combinations of relative movements of the first extension pole member, the second extension pole member and the extremity support allow the apparatus to be disposed and secured in positions that support an extremity of a patient lying on the emergency cot and wherein certain other combinations of relative movements of the first extension pole member, the second extension pole member and the extremity support allow the apparatus to be disposed and secured in storage positions.

20. The apparatus of claim 19 wherein the cot attachment moveable linkage is a ball and socket linkage.

21. The apparatus of claim 19 wherein the extremity support member is rotatably coupled to the distal end of the of the second extension pole member by means of a ball and socket linkage.

22. A method of affording extremity support for a patient being transported in an emergency cot comprising the steps of:
i. providing the apparatus of claim 1;
ii. attaching the apparatus to an emergency cot;
iii. adjusting and securing the apparatus in a position appropriate for supporting a patient's extremity; and
iii. disposing the patient's extremity within the support member.
